(19) United States
(12) Patent Application Publication
(10) Pub. No.: US 2015/0375133 A1
(43) Pub. Date: Dec. 31, 2015

(54) MODULAR CONSTRUCTION SYSTEM

(71) Applicant: Michael Connor, Porter, TX (US)

(72) Inventor: Michael Connor, Porter, TX (US)

(21) Appl. No.: 14/735,912

(22) Filed: Jun. 10, 2015

Related U.S. Application Data
(60) Provisional application No. 62/017,033, filed on Jun. 25, 2014.

(51) Int. Cl. A63H 33/10; G06F 17/50

(52) U.S. Cl. CPC A63H 33/107; G06F 17/5004

(57) ABSTRACT

A modular construction system that is adapted to create structures and comprises a link, a first beam, and a second beam. The first beam includes sides and ends, wherein the sides of the first beam each include an engagement slot adapted to receive the link and maintain engagement therewith through a friction fit. Furthermore, the ends of the first beam each include a cross-slot adapted to receive the link and maintain engagement therewith through a friction fit. The second beam including sides and ends, wherein the sides of the second beam each include an engagement slot adapted to receive the link and maintain engagement therewith through a friction fit. In addition, the ends of the second beam each include a cross-slot adapted to receive the link and maintain engagement therewith through a friction fit such that the link connects the first beam with the second beam.

### BACKGROUND OF THE INVENTION

1. Field of the Invention

The present invention relates generally to a modular construction system and more particularly, to a modular construction system that can be utilized in a professional setting for creating prototypes, or as a toy to create structures.

2. Description of the Related Art

Readily available modular construction systems consist of low cost systems used as toys and high cost custom made systems that are typically used to create prototypes. Examples of modular constructions systems that are low cost, readily available, and typically used as toys include Legos™, Knex™, and Erector Set™. These low cost systems work well as toys, however, when applied to create prototypes several problems arise. Specifically, LEGOS™ use a snap construction that does not provide a rigid connection between pieces and does not allow for angular design in construction. In contrast, Erector Set™ uses nuts and bolts to provide a more rigid construction and more flexibility in design, however, they do not lend themselves well for designs that require three dimensions.

Examples of modular constructions systems that are used more in a professional setting to create prototypes include; T-slotted Aluminum and Unistrut. These systems create sturdy and professional looking structures that allow an operator to create custom designs. However, these systems require cutting tools to cut pieces to length as well as expensive hardware, therefore these systems are not reusable and are expensive.

Accordingly a modular construction system that can bridge the gap between low cost readily available systems that are typically used as toys and high cost custom made systems that are typically used to create prototypes would be useful.

### SUMMARY OF THE INVENTION

The present invention is a modular construction system adapted to create structures. The modular construction system comprises a link, a first beam, a second beam, at least a first adapter, a plate, and a biasing member. The link includes a central axis, a first end, a second end, and a plurality of apertures wherein the link facilitates arrangement of the first and second beam in a side-to-side configuration, a side-to-end configuration, or an end-to-end configuration.

The first beam includes sides and ends, wherein the sides of the first beam each include an engagement slot adapted to receive the link and maintain engagement therewith through a friction fit. Furthermore, the ends of the first beam each include a cross-slot adapted to receive the link and maintain engagement therewith through a friction fit.

The second beam including sides and ends, wherein the sides of the second beam each include an engagement slot adapted to receive the link and maintain engagement therewith through a friction fit. Moreover, the ends of the second beam each include a cross-slot adapted to receive the link and maintain engagement therewith through a friction fit such that the link connects the first beam with the second beam.

The first adapter includes a stud and a body adapted to engage the cross-slots and engagement slots of the first and second beam. The body includes faces and an aperture adapted to receive a bolt or a stud of a second adapter and the stud is adapted to engage the apertures of the link or an aperture of the second adapter.

The plate includes apertures adapted to receive the stud of the first adapter, wherein, the first adapter facilitates the coupling of the plate and the first or second beam. In particular, the stud of the first adapter inserts through an aperture of the plate such that a nut engaging the stud locks the first adapter to the plate. This feature allows the first or second beam to couple to the plate. Specifically, insertion of the body of the first adapter through an engagement slot or cross slot of the first or second beam aligns the aperture of the first adapter with adjacent engagement slots of the first or second beam such that a bolt or the stud of the second adapter received in the aperture locks the first adapter with the second beam, thereby coupling the plate and the first or second beam.

The biasing member imparts movement into the modular construction system. For example, insertion of the first end of the link through a cross slot of the first beam aligns an aperture of the link with engagement slots of the first beam such that a bolt or a stud of the first adapter received in the aperture locks the link with the first beam. The biasing member inserts over the link such that a first end of the biasing member engages an end of the first beam. Insertion of the second end of the link through a cross slot of the second beam aligns an aperture of the link with engagement slots of the second beam such that a bolt or a stud of the second adapter received in the aperture locks the link with the second beam, thereby coupling the first and second beams. Furthermore, a second end of the biasing member engages an end of the second beam. A compression force imparted into the first and second beam moves the first beam and second beam toward each other, further wherein, upon release of the compression force the biasing member bias the first and second beam away from each other.

As described above, the link facilitates arrangement of the first and second beam in a side-to-side configuration, a side-to-end configuration, or an end-to-end configuration. To facilitate the arrangement of the first and second beam in a side by side configuration, the first end of the link resides within an engagement slot of either the first or second beam. In addition, the central axis of the link is placed at a 45 degree angle relative to the central axis of the first or second beam. After the link is placed at a 45 degree angle, the second end of the link inserts within an engagement slot of the first or second beam thereby facilitating the arrangement of the first and second beam in a side by side configuration.

To facilitate the arrangement of the first and second beam in a side to end configuration, the first end of the link resides within an engagement slot of either the first or second beam such that the central axis of the link resides at any angle between a perpendicular and a 45 degree angle relative to a central axis of either the first or second beam. The second end of the link is then inserted within a cross slot of the first or second beam thereby facilitating the arrangement of the first and second beam in a side to end configuration.

To facilitate the arrangement of the first and second beam in an end to end configuration, the first end of the link resides within a cross slot of either the first or second beam and the second end of the link resides within a cross slot of the first or second beam.

In addition to facilitating the arrangement of the first and second beam, the link may also facilitate the arrangement of the first and second beam and a third beam. The third beam including sides and ends, wherein the sides of the third beam each include an engagement slot adapted to receive the link and maintain engagement therewith through a friction fit. Moreover, the ends of the third beam each include a cross-slot adapted to receive the link and maintain engagement therewith through a friction fit such that the link connects the third beam with first and second beam. For example, the link facilitates the arrangement of the first, the second, and the third beam in a side-to-side configuration whereby, the first end of the link resides within an engagement slot of the first beam and the second end of the link inserts within an engagement slot of the second beam and the third beam thereby facilitating the arrangement of the first, second, and third beam in a side by side configuration. The link also facilitates the arrangement of the first, second, and third beam in a T-configuration whereby the link traverses engagement slots of the first beam and engages a cross-slot of the second and third beams.

The apertures in the link allow the coupling of the first beam, the second beam, and the third beam to the link. In an example using the first beam, insertion of the link through an engagement slot or cross slot of the first beam aligns an aperture of the link with adjacent engagement slots of the first beam such that a bolt or a stud of the first adapter received in the aperture locks the link with the first beam. Once the link couples with the first beam, the link may insert into an engagement slot or a cross slot of the second or third beam to couple the first beam to the second or third beam. For example, insertion of the first end of the link through an engagement slot of the first beam such that the central axis of the link resides at a perpendicular angle relative to a central axis of the first beam aligns an aperture of the link with adjacent engagement slots of the first beam. A bolt or a stud of the first adapter received in the aperture locks the link with the first beam. Insertion of the second end of the link through an engagement slot of the second beam such that the central axis of the link resides at a perpendicular angle relative to a central axis of the second beam aligns an aperture of the link with adjacent engagement slots of the second beam. A bolt or a stud of the second adapter in the aperture locks the link with the second beam, thereby coupling the first and second beams. Furthermore, insertion of the second end of the link through an engagement slot of a third beam such that the central axis of the link resides at a perpendicular angle relative to a central axis of the third beam aligns an aperture of the link with engagement slots of the third beam. A bolt or a stud of a third adapter received in the aperture locks the link with the third beam, thereby coupling the first, second, and third beams.

As described above, the stud of the first adapter is adapted to engage the apertures of the link or an aperture of the second adapter. Furthermore, the stud of the first adapter is positionable within the aperture of the link such that the faces of the first adapter reside parallel, perpendicular, or any angle between parallel and perpendicular to the central axis of the link. This feature allows the rotational and angled coupling of the first beam, the second beam, and the third beam with the link. For example using the first beam, the stud of the first adapter inserts through an aperture of the link such that a nut or an aperture of the second adapter engaging the stud locks the first adapter to the link. Insertion of the body of the first adapter through a cross slot or an engagement slot of the first beam aligns the aperture of the first adapter with adjacent engagement slots of the first beam such that a bolt or the stud of the second adapter received in the aperture locks the first adapter with the first beam, thereby coupling the link and the first beam. As described above, because the faces of the first adapter reside parallel, perpendicular, or any angle between parallel and perpendicular to the central axis of the link the first or second beam resides parallel, perpendicular, or any angle between parallel and perpendicular to the central axis of the link. Furthermore, when the first adapter is inserted into an engagement slot of a first or second beam, the design of the first adapter allows the central axis of the first, the second, or the third beam to reside at an angle between 0 and 30 degrees compared to the body of the link.

In addition to allowing rotational and angled coupling of the first beam, the second beam, and the third beam with the link, the adapter also allows the rotational and angled coupling of a first beam and a second beam. For example, insertion of the first end of the link through a cross slot of the first beam aligns an aperture of the link with adjacent engagement slots of the first beam such that the stud of the first adapter received in the aperture locks the first adapter and the link with the first beam, further wherein, the stud of the first adapter is positionable within the aperture of the link such that the faces of the adapter reside parallel, perpendicular, or any angle between parallel and perpendicular to a central axis of the first beam. Insertion of the body of the first adapter through an engagement slot of the second beam aligns the aperture of the first adapter with adjacent engagement slots of the second beam, such that a bolt or the stud of a second adapter received in the aperture locks the first adapter with the second beam, thereby coupling the first and second beams. Furthermore, the central axis of the second beam may reside at an angle between 0 and 30 degrees compared to the body of the link thereby by creating an angled coupling between the first beam and the second beam.

Although the modular construction system has been described herein comprising a link, a first beam, a second beam, at least a first adapter, a plate, and a biasing member, the modular construction system in practice comprises a plurality of links, a plurality of beams, a plurality of adapters, a plurality of plates, and a plurality of biasing members. As such, a method of creating structures using the modular construction system comprises combining the plurality of links, the plurality of beams, the plurality of adapters, the plurality of plates, and the plurality of biasing members using bolts, nuts, and the studs of the adapters to create structures.

### BRIEF DESCRIPTION OF DRAWINGS

FIG. 1 is a perspective view illustrating a first beam of the modular construction system.

FIG. 2 is a perspective view illustrating a second beam of the modular construction system.

FIG. 3 is a perspective view illustrating a third beam of the modular construction system.

FIG. 4 is a perspective view illustrating a link of the modular construction system.

FIG. 5 is a perspective view illustrating an adapter of the modular construction system.

FIG. 6 is a perspective view illustrating a plate of the modular construction system.

FIG. 7 is a perspective view illustrating the coupling of the first beam to the plate using the adapter.

FIG. 8 is a perspective view illustrating a bolt of the modular construction system.

FIG. 9 is a perspective view illustrating a head of the bolt engaging a cross-slot of the first beam in a press fit.

FIG. 10 is a perspective view illustrating a nut of the modular construction system.

FIGS. 11-14 are perspective views illustrating the link engaging engagement slots of the first beam.

FIGS. 15-18 are perspective views illustrating the link engaging a cross slot of the first beam.

FIG. 18 is a cross-sectional view illustrating the beverage-dispensing nozzle according to a second embodiment.

FIG. 19 is a perspective view illustrating the adapter engaging engagement slots of the first beam.

FIG. 20 is a perspective view illustrating the adapter engaging a cross slot of the first beam.

FIG. 21 is a perspective view illustrating a side to side coupling of the first beam with the second beam using the link.

FIG. 22 is a perspective view illustrating a side to side coupling of the first beam, the second beam, and the third beam using the link.

FIG. 23 is a perspective view illustrating an end to end coupling of the first beam with the second beam using the link.

FIG. 24 is a perspective view illustrating a right angle coupling of the first beam with the second beam using the link.

FIG. 25 is a perspective view illustrating a T coupling of the first beam, the second beam, and the third beam using the link.

FIG. 26 is a perspective view illustrating an angled coupling of the first beam with the second beam using the link.

FIG. 27 is a perspective view illustrating a rotational feature of the modular construction system using the adapter, the link, the first beam and the second beam.

FIG. 28 is a perspective view illustrating a right angle coupling of the modular construction system using the adapter, the link, the first beam and the second beam.

FIG. 29 is a perspective view illustrating an angled coupling of the modular construction system using the adapter, the link, the first beam and the second beam.

FIG. 30 is a perspective view illustrating a rotational angled coupling of the modular construction system using the adapter, the link, the first beam and the second beam.

FIG. 31 is a perspective view illustrating a biasing member of the modular construction system.

FIG. 32 is a perspective view illustrating the biasing member placed over the link and between the first beam and the second beam.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps.

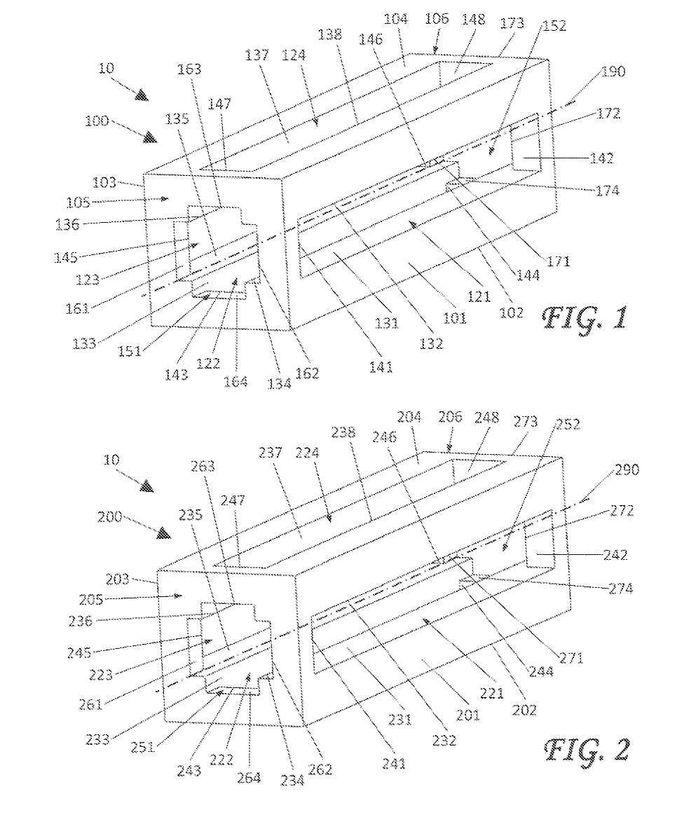

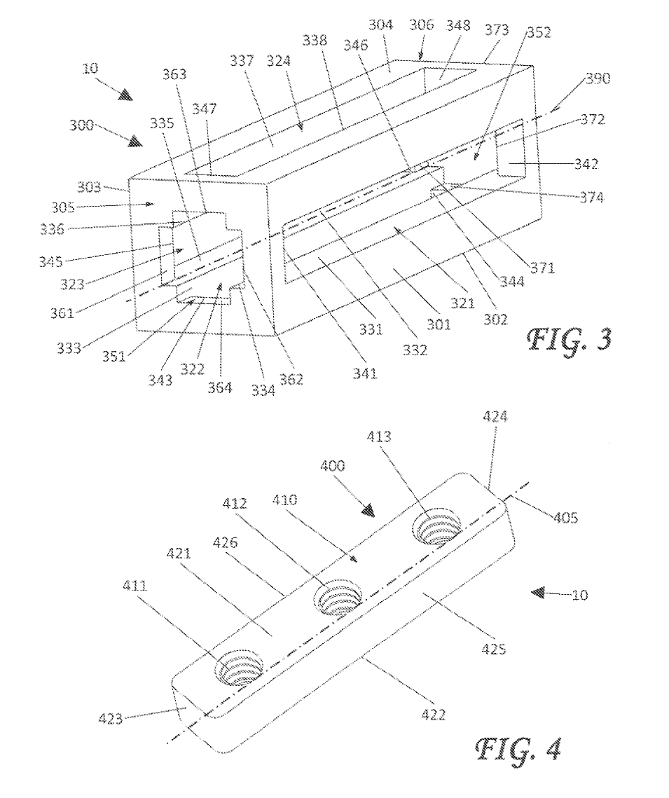

FIGS. 1-30 illustrate a modular construction system 10. The modular construction system 10 includes a beam 100, a link 400, an adapter 500, a plate 600, bolts 700, nuts 800, and biasing members 900 that combine together to form structures. In addition a beam 200 and a beam 300 are described herein to aid in the understanding of various structures that are capable of being formed by the modular construction system 10. In order to form a structure, any number of beams 100-300, links 400, adapters 500, plates 600, bolts 700, nuts 800, and biasing members 900 may be included in the modular construction system 10. Any suitable material such as plastic, wood, or metal, may be used to construct the modular construction system 10, however, in the preferred embodiment, the modular construction system 10 is constructed using plastic. Furthermore, the modular construction system 10 can be manufactured using any suitable means such as injection molding, milling, extruding, or 3D printing.

FIGS. 1-3 illustrate the beam 100, the beam 200, and the beam 300. The beam 100, the beam 200, and the beam 300 are identical and couple with each other through engagement with the link 400, the adapter 500, the plate 600, the bolts 700, and the nuts 800. Furthermore, the beam 100, the beam 200, and the beam 300 include a friction fit engagement feature that allows structures constructed using the modular construction system 10 to hold their shape without the necessity of a fastener such as the bolts 700 or the nuts 800. Once a final form of the structure is completed, a fastener such as the bolts 700 or the nuts 800 can be added to the structure to increase rigidity. The friction fit engagement feature of the beam 100, the beam 200, and the beam 300 will be explained in greater detail herein. In addition, those of ordinary skill in the art will recognize that the beam 100, the beam 200, and the beam 300 may be any length suitable for the construction of structures.

The beam 100 is rectangular in shape and includes a central axis 190, sides 101-104, and ends 105 and 106. The sides 101-104 include engagement slots 121-124. The engagement slot 121 includes longitudinal engagement surfaces 131 and 132 and end engagement surfaces 141 and 142. The engagement slot 122 includes longitudinal engagement surfaces 133 and 134 and end engagement surfaces 143 and 144. The engagement slot 123 includes longitudinal engagement surfaces 135 and 136 and end engagement surfaces 145 and 146. The engagement slot 124 includes longitudinal engagement surfaces 137 and 138 and end engagement surfaces 147 and 148. The engagement slots 121-124 are oriented 90-degrees to each other around the central axis 190, and are adapted to receive the link 400 and the adapter 500. In particular, the engagement slots 121-124 receives through a friction fit engagement one or more links 400 and adapters 500 in multiple configurations and combinations.

The ends 105 and 106 of the beam 100 include cross-slots 151 and 152. The cross-slots 151 and 152 include engagement surfaces 161-164 and 171-174 respectively. The cross-slots 151 and 152 are adapted to receive the link 400, the adapter 500, and the bolt 800. In particular, the cross-slots 151 and 152 can each receive one link 400, adapter 500 or bolt 800 through a friction fit engagement.

The beam 200 is rectangular in shape and includes a central axis 290, sides 201-204, and ends 205 and 206. The sides 201-204 include engagement slots 221-224. The engagement slot 221 includes longitudinal engagement surfaces 231 and 232 and end engagement surfaces 241 and 242. The engagement slot 222 includes longitudinal engagement surfaces 233 and 234 and end engagement surfaces 243 and 244. The engagement slot 223 includes longitudinal engagement surfaces 235 and 236 and end engagement surfaces 245 and 246. The engagement slot 224 includes longitudinal engagement surfaces 237 and 238 and end engagement surfaces 247 and 248. The engagement slots 221-224 are oriented 90-degrees to each other around the central axis 290, and are adapted to receive the link 400 and the adapter 500. In particular, the engagement slots 221-224 receives through a friction fit engagement one or more links 400 and adapters 500 in multiple configurations and combinations.

The ends 205 and 206 of the beam 200 include cross-slots 251 and 252. The cross-slots 251 and 252 include engagement surfaces 261-264 and 271-274 respectively. The cross-slots 251 and 252 are adapted to receive the link 400, the adapter 500, and the bolt 800. In particular, the cross-slots 251 and 252 can each receive one link 400, adapter 500 or bolt 800 through a friction fit engagement.

The beam 300 is rectangular in shape and includes a central axis 390, sides 301-304, and ends 305 and 306. The sides 301-304 include engagement slots 321-324. The engagement slot 321 includes longitudinal engagement surfaces 331 and 332 and end engagement surfaces 341 and 342. The engagement slot 322 includes longitudinal engagement surfaces 333 and 334 and end engagement surfaces 343 and 344. The engagement slot 323 includes longitudinal engagement surfaces 335 and 336 and end engagement surfaces 345 and 346. The engagement slot 324 includes longitudinal engagement surfaces 337 and 338 and end engagement surfaces 347 and 348. The engagement slots 321-324 are oriented 90-degrees to each other around the central axis 390, and are adapted to receive the link 400 and the adapter 500. In particular, the engagement slots 321-324 receives through a friction fit engagement one or more links 400 and adapters 500 in multiple configurations and combinations.

The ends 305 and 306 of the beam 300 include cross-slots 351 and 352. The cross-slots 351 and 352 include engagement surfaces 361-364 and 371-374 respectively. The cross-slots 351 and 352 are adapted to receive the link 400, the adapter 500, and the bolt 800. In particular, the cross-slots 351 and 352 can each receive one link 400, adapter 500 or bolt 800 through a friction fit engagement.

FIG. 4 illustrates the link 400. The link 400 engages the beam 100, the beam 200, and the beam 300 to allow the beam 100, the beam 200, and the beam 300 to couple to each other. The link 400 includes a body 410 further including a central axis 405, faces 421 and 422, ends 423 and 424, sides 425 and 426, and apertures 411-413. The ends 423 and 424 are rounded to facilitate engagement with the engagement slots 121-124 and the cross-slots 151 and 152 of the beam 100, the engagement slots 221-224 and the cross-slots 251 and 252 of the beam 200, and the engagement slots 321-324 and the cross-slots 351 and 352 of the beam 300. The apertures 411 and 413 are located near the ends 423 and 424 respectively and the aperture 412 is located at the mid-point of the body 410. The apertures 411-413 are threaded in order to receive and secure the adapter 500, or the bolts 700. In the preferred embodiment, the body 410 of the link 400 includes three apertures 411-413, however, one of ordinary skill in the art will recognize that the link 400 may be lengthened or shortened and include more apertures or as few as two apertures depending upon application.

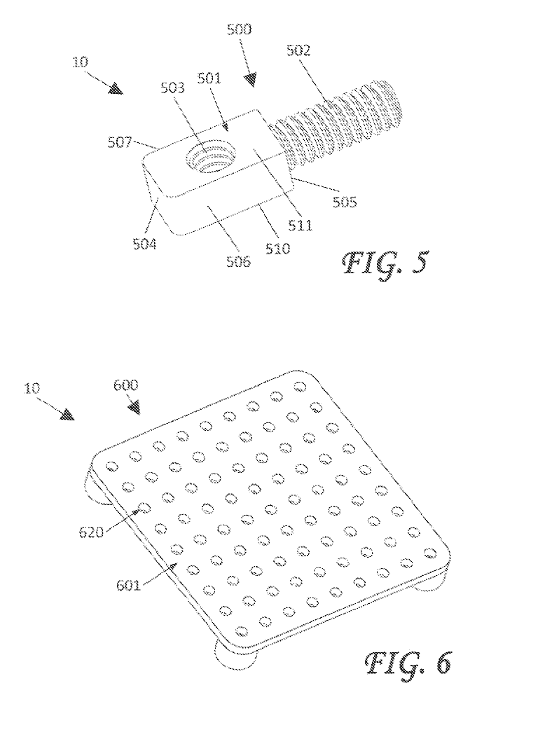

FIG. 5 illustrates the adapter 500. The adapter 500 engages the beam 100, the beam 200, the beam 300, and the link 400 to facilitate the coupling of the beam 100, the beam 200, and the beam 300. Furthermore, the adapter 500 facilitates angled and rotational coupling of the beam 100, the beam 200, and the beam 300.

The adapter 500 includes a body 501 and a stud 502. The body 501 of the adapter 500 includes faces 510 and 511, an aperture 503, an end 504, a base 505, and sides 506 and 507. The end 504 of the adapter 500 is rounded to facilitate engagement with the engagement slots 121-124 and the cross-slots 151 and 152 of the beam 100, the engagement slots 221-224 and the cross-slots 251 and 252 of the beam 200, and the engagement slots 321-324 and the cross-slots 351 and 352 of the beam 300. The aperture 503 is threaded to receive the bolts 700 or the stud of another adapter. The stud 502 attaches at a first end to the base 505 of the body 501 and includes threads. The threads engage the apertures 411-413 of the link 400 and the nuts 800 in order to secure the adapter 500 to the link 400 or the plate 600 respectively. Furthermore, the adapter 500 is positionable within the apertures 411-413 of the link 400 such that the faces 510 and 511 of the adapter 500 reside parallel, perpendicular, or any angle between parallel and perpendicular with the central axis 405 of the link 400. In the preferred embodiment, the body 501 of the adapter 500 includes one aperture 503, however, one of ordinary skill in the art will recognize that body 501 of the adapter 500 may be lengthened to include more apertures depending upon application.

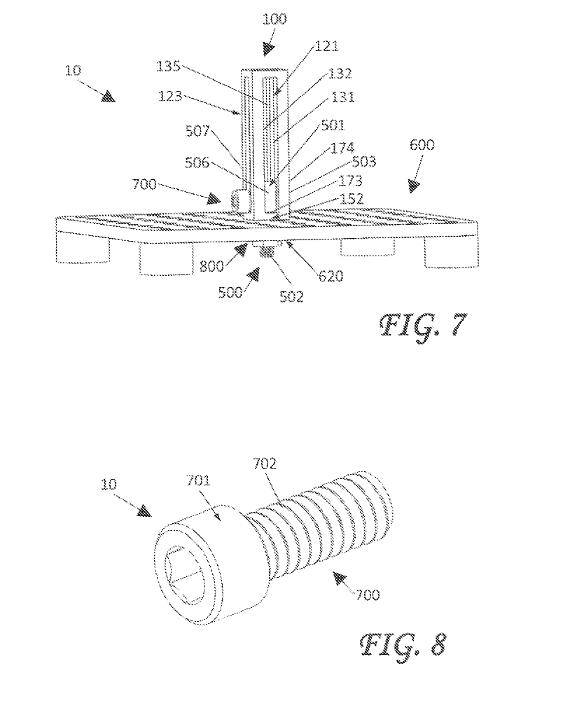

FIG. 6 illustrates the plate 600. The plate 600 includes a body 601 and apertures 620. The plate 600 provides a building platform for the modular construction system 10. In particular, the apertures 620 of the plate 600 receive the adapter 500 or the bolts 700 to facilitate the coupling of the beam 100, the beam 200, and the beam 300 to the plate 600. FIG. 7 illustrates the coupling of the beam 100 to the plate 600 using the adapter 500. The stud 502 of the adapter 500 is placed through an aperture 620 of the plate 600. A nut 800 engages the stud 502 to secure the adapter 500 to the plate 600. The body 501 of the adapter 500 inserts through the cross slots 152 of the beam 100 such that the sides 506 and 507 of the body 501 engage the cross-slot 152 in a friction fit. To further secure the coupling of the beam 100 to the plate 600, the bolt 700 engages the aperture 503 of the adapter 500.

FIG. 8 illustrates the bolts 700 of the modular construction system 10. The bolts 700 of the modular construction system 10 include a head 701 and a stud 702. The head 701 in the preferred embodiment of the modular construction system 10 includes a hex engagement surface, however one of ordinary skill in the art would recognize that any engagement surface may be used. In addition, the head 701 of the bolts 700 are designed to engage the cross-slots 151 and 152 of the beam 100, the cross-slots 251 and 252 of the beam 200, and the cross-slots 351 and 352 of the beam 300. In particular, as illustrated in FIG. 9 using the beam 100, the head 701 of the bolts 700 engages the cross-slots 152 of the beam 100 in a press-fit that allows the coupling of the beam 100 and the bolts 700.

FIG. 10 illustrates the nuts 800 of the modular construction system 10. The nuts 800 include bodies 801 and threads 802. The threads 802 of the nuts 800 are designed to engage the stud 502 of the adapter 500 and the stud 702 of the bolts 700.

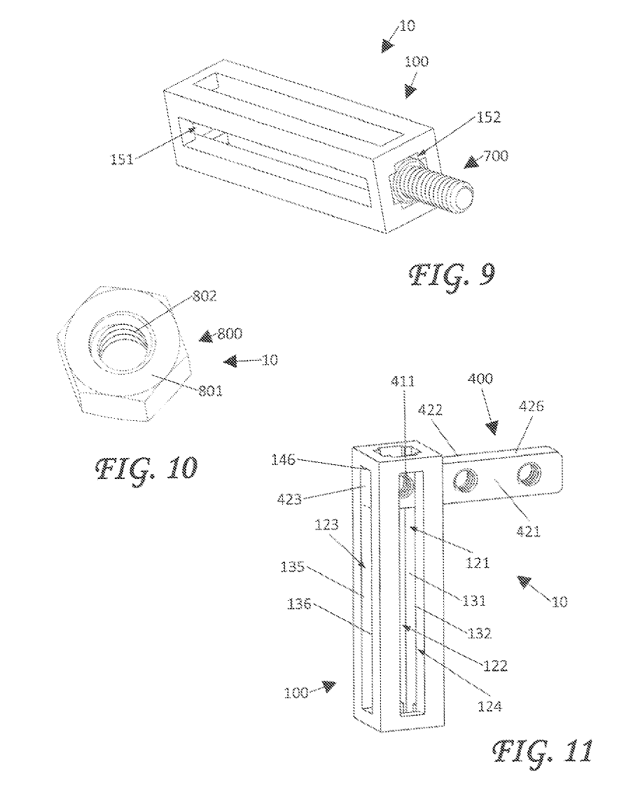

FIGS. 11-14 illustrate the link 400 engaging the engagement slots 121 and 123 of the beam 100. The link 400 is designed to engage the engagement slots 121-124 of the beam 100, however, further herein, the link 400 will be described only engaging the engagement slot 121 and 123 of the beam 100 on the basis that the engagement slots 121-124 are identical and the link 400 engages the engagement slots 121-124 in the same manner.

To engage the engagement slot 121 and 123, the end 423 of the link 400 inserts into the engagement slot 121 and into the engagement slot 123. Furthermore, the faces 421 and 422 of the link 400 engage the longitudinal engagement surfaces 131 and 132 of the engagement slot 121 and the longitudinal engagement surfaces 135 and 136 of the engagement slot 123 in a friction fit that allows the link 400 to hold a position within the beam 100 without the necessity of a fastener such as the bolts 700.

The link 400 may insert into the engagement slot 121 at any position, however, FIGS. 11-13 illustrate, inserting the link 400 into the engagement slot 121 and into the engagement slot 123 such that the side 426 of the link 400 engages the end engagement surface 142 of the engagement slot 121 and the end engagement surface 146 of the engagement slot 123. Furthermore, the link 400 may insert into the engagement slot 121 and reside in any final position within the beam 100 that facilitates the coupling of the beam 200 or the beam 300 with the beam 100.

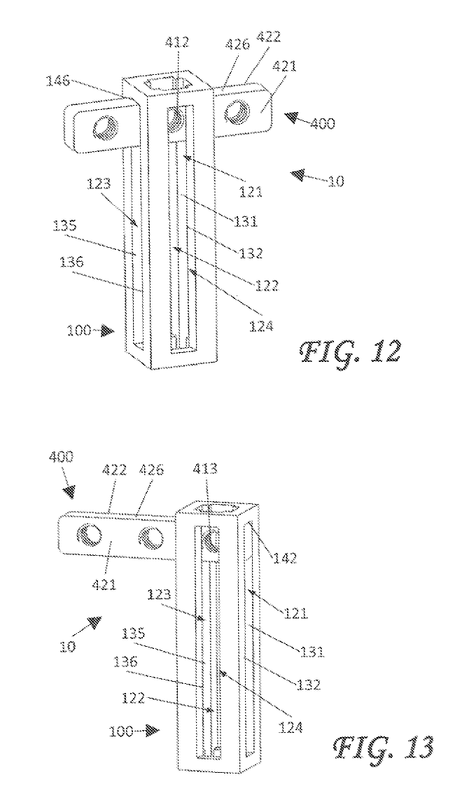

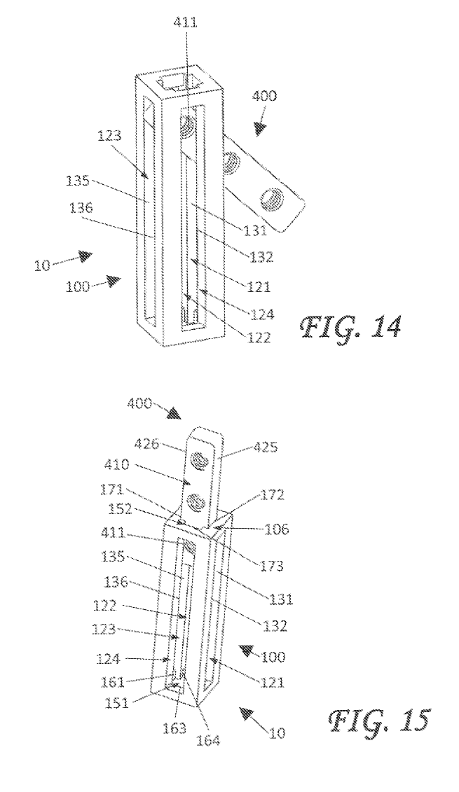

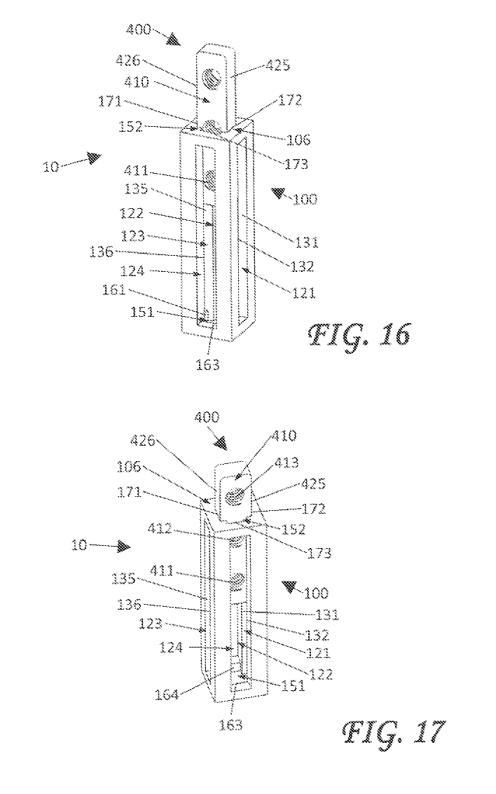

FIG. 11 illustrates the insertion of the link 400 into the engagement slot 121 and into the engagement slot 123 of the beam 100 such that the aperture 411 of the link 400 aligns with the engagement slot 122 and 124 of the beam 100. FIG. 12 illustrates the insertion of the link 400 into the engagement slot 121 and the engagement slot 123 of the beam 100 such that aperture 412 of the link 400 aligns with the engagement slot 122 and 124 of the beam 100. FIG. 13 illustrates the insertion of the link 400 into the engagement slot 121 and the engagement slot 123 of the beam 100 such that aperture 413 of the link 400 aligns with the engagement slot 122 and 124 of the beam 100. FIG. 14 illustrates the insertion of the link 400 at an angle of approximately 45 degrees into the engagement slot 121 and the engagement slot 123 of the beam 100 such that aperture 411 of the link 400 aligns with the engagement slot 122 and 124 of the beam 100. Insertion of the link 400 at an angle of approximately 45 degrees into engagement slot 121 and 123 facilitates a side-to-side or angled coupling of the beam 100 with the beam 200 or the beam 300 and will be described with greater detail herein.

FIGS. 15-18 illustrate the link 400 engaging the cross slot 152 of the beam 100. To engage the cross slot 151 or 152 of the beam 100, the body 410 of the link 400 inserts into the cross slot 151 or 152 of the beam 100. Specifically, when inserting into the cross slot 151, the sides 425 and 426 of the body 410 engage the engagement surfaces 161 and 162 or the engagements surfaces 163 and 164. Furthermore, when inserting into the cross slot 152, the sides 425 and 426 of the body 410 engage the engagement surfaces 171 and 172 or the engagements surfaces 173 and 174. Further herein as illustrated in FIGS. 15-18, the link 400 will be described only engaging the engagement surfaces 171 and 172 of the cross-slot 152 on the basis that the cross slot 151 and 152 are identical and the link 400 engages both the engagement surfaces 161-164 of the cross slot 151 and the engagement surfaces 171-174 of the cross slot 152 in the same manner.

Upon insertion into the cross slot 152, the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit. Upon the link 400 engaging the cross slot 152, the friction fit described above allows the link 400 to hold a position within the beam 100 without a fastener such as the bolts 700.

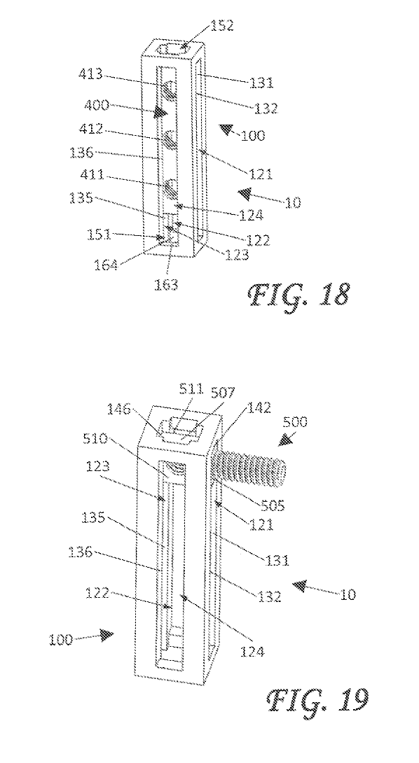

The link 400 may insert into the cross slot 152 of the beam 100 and reside in any final position within the beam 100 that facilitates the coupling of the beam 200 or the beam 300 with the beam 100. FIG. 15 illustrates the insertion of the link 400 into the cross slot 152 of the beam 100 such that the aperture 411 of the link 400 aligns with the engagement slot 122 and 124 of the beam 100. FIG. 16 illustrates the insertion of the link 400 into the cross slot 152 of the beam 100 such that the aperture 411 of the link 400 aligns with the engagement slot 122 and 124 of the beam 100 and the mid-point of the link 400 aligns with the end 106 of the beam 100. FIG. 17 illustrates the insertion of the link 400 into the cross slot 152 of the beam 100 such that the aperture 411 and 412 of the link 400 aligns with the engagement slot 122 and 124 of the beam 100. FIG. 18 illustrates the insertion of the link 400 into the cross slot 152 of the beam 100 such that the aperture 411-413 of the link 400 aligns with the engagement slot 122 and 124 of the beam 100.

FIG. 19 illustrates the adapter 500 engaging the engagement slots 121 and 123 of the beam 100. The adapter 500 may engage the engagement slots 121-124 of the beam 100, however, further herein, the adapter 500 will be described only engaging the engagement slot 121 and 123 of the beam 100 on the basis that the engagement slots 121-124 are identical and engage the link 400 in the same manner.

To engage the engagement slot 121 and 123, the end 504 of the adapter 500 inserts into the engagement slot 121 and into the engagement slot 123 such that the faces 510 and 511 of the adapter 500 engage the longitudinal engagement surfaces 131 and 132 of the engagement slot 121 and the longitudinal engagement surfaces 135 and 136 of the engagement slot 123. Furthermore, the adapter 500 engages the engagement slot 121 and into the engagement slot 123 of the beam 100 in a friction fit that allows the adapter 500 to hold a position within the beam 100 without the necessity of a fastener such as the bolts 700.

The body 501 of the adapter 500 may insert into the engagement slot 121 at any position, however, FIG. 19 illustrates, inserting the body 501 of the adapter 500 into the engagement slot 121 and into the engagement slot 123 such that the side 507 of the adapter 500 engages the end engagement surface 142 of the engagement slot 121 and the end engagement surface 146 of the engagement slot 123.

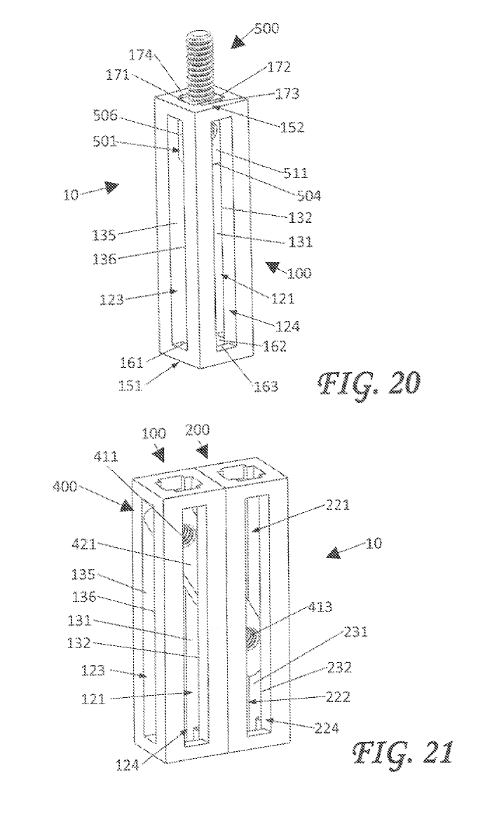

FIG. 20 illustrates the adapter 500 engaging the cross slot 152 of the beam 100. The adapter may engage the cross slot 151 or the cross slot 152. In particular, the body 501 of the adapter 500 inserts into the cross slot 151 or the cross slot 152 of the beam 100 such that the sides 506 and 507 of the adapter 500 engage the engagement surfaces 161-164 of the cross slot 151 or the engagement surfaces 171-174 of the cross slot 152. Specifically, the body 501 of the adapter 500 inserts into the cross slot 151 such that the sides 506 and 507 of the adapter 500 engage the engagement surfaces 161 and 162 or the engagements surfaces 163 and 164. Furthermore, the body 501 of the adapter 500 inserts into the cross slot 152 such that the sides 506 and 507 of the adapter 500 engage the engagement surfaces 171 and 172 or the engagements surfaces 173 and 174. Further herein, the adapter 500 will be described only engaging the engagement surfaces 171 and 172 of the cross-slot 152 on the basis that the cross slot 151 and 152 are identical and adapter 500 engages both the engagement surfaces 161-164 of the cross slot 151 and the engagement surfaces 171-174 of the cross slot 152 in the same manner.

The body 501 of the adapter 500 inserts into the cross slot 152 such that the sides 506 and 507 of the adapter 500 engage the engagement surfaces 171 and 172 of the cross-slot 152 in a friction fit. In addition, the faces 510 and 511 of the adapter 500 engage the longitudinal engagement surfaces 131 and 132 of the engagement slot 121 and the longitudinal engagement surfaces 135 and 136 of the engagement slot 123 in a friction fit. Upon the adapter 500 engaging the cross slot 152, the friction fit described above allows the adapter 500 to hold a position within the beam 100 without a fastener such as the bolts 700.

FIGS. 21-26 illustrate some example structures that can be constructed using the link 400, the beam 100, the beam 200, and the beam 300. FIGS. 21-26 are not all inclusive of every combination using, the link 400, the beam 100, the beam 200, and the beam 300.

FIG. 21 illustrates a side to side coupling of the beam 100 with the beam 200 using the link 400. The link 400 inserts at an approximate 60 degree angle into the engagement slot 121 and into the engagement slot 123 such that the faces 421 and 422 of the link 400 engage the longitudinal engagement surfaces 131 and 132 of the engagement slot 121 and the longitudinal engagement surfaces 135 and 136 of the engagement slot 123 in a friction fit. In addition, the aperture 411 of the link 400 aligns with the engagement slot 122 and 124 of the beam 100.

The link 400 then inserts at an approximate 60 degree angle into the engagement slot 223 and the engagement slot 221 such that the faces 421 and 422 of the link 400 engage the longitudinal engagement surfaces 235 and 236 of the engagement slot 223 and the longitudinal engagement surfaces 231 and 232 of the engagement slot 221 in a friction fit. After inserting into the engagement slot 223 and 221 of the beam 200, the aperture 413 of the link 400 aligns with engagement slot 222 and 224 of the beam 200.

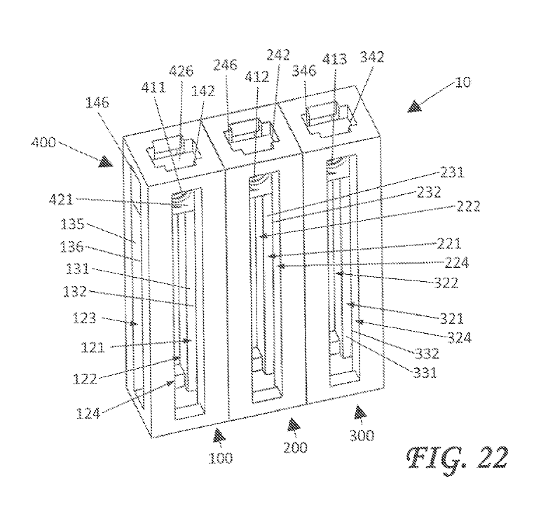

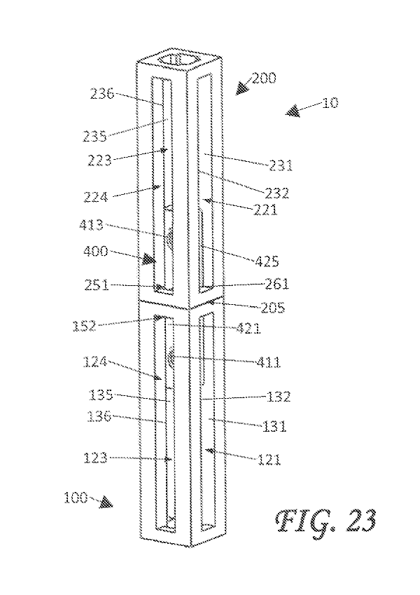

FIG. 22 illustrates a side to side coupling of the beam 100, the beam 200, and the beam 300 using the link 400. The link 400 inserts into the engagement slot 121 and the engagement slot 123 of the beam 100 such that the faces 421 and 422 of the link 400 engage the longitudinal engagement surfaces 131 and 132 of the engagement slot 121 and the longitudinal engagement surfaces 135 and 136 of the engagement slot 123 in a friction fit. In addition, the side 426 of the link 400 engages the end engagement surface 142 of the engagement slot 121 and the end engagement surface 146 of the engagement slot 123. Furthermore, the link 400 inserts through the engagement slot 121 and the engagement slot 123 of the beam 100 such that the aperture 411 of the link 400 aligns with the engagement slot 122 and 124 of the beam 100.

The link 400 then inserts into the engagement slot 223 and the engagement slot 221 of the beam 200 such that the faces 421 and 422 of the link 400 engage the longitudinal engagement surfaces 235 and 236 of the engagement slot 223 and the longitudinal engagement surfaces 231 and 232 of the engagement slot 221 in a friction fit. In addition, the side 426 of the link 400 engages the end engagement surface 246 of the engagement slot 223 and the end engagement surface 242 of the engagement slot 221 Furthermore, the link 400 inserts through the engagement slot 223 and the engagement slot 221 of the beam 200 such that the aperture 412 of the link 400 aligns with the engagement slot 222 and 224 of the beam 200.

After the link 400 inserts into the beam 200, the link 400 inserts into the engagement slot 323 and the engagement slot 321 of the beam 300 such that the faces 421 and 422 of the link 400 engage the longitudinal engagement surfaces 335 and 336 of the engagement slot 323 and the longitudinal engagement surfaces 331 and 332 of the engagement slot 321 in a friction fit. In addition, the side 426 of the link 400 engages the end engagement surface 346 of the engagement slot 323 and the end engagement surface 342 of the engagement slot 321 Furthermore, the link 400 inserts through the engagement slot 323 and the engagement slot 321 of the beam 300 such that the aperture 413 of the link 400 aligns with the engagement slot 322 and 324 of the beam 300.

FIG. 23 illustrates an end-to-end coupling of the beam 100 and the beam 200 using the link 400. The link 400 inserts into the cross slot 152 of the beam 100 such that the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit. Furthermore, the aperture 411 of the link 400 aligns with the engagement slot 122 and 124 of the beam 100 and the mid-point of the link 400 aligns with the end 106 of the beam 100.

The link 400 then inserts into the cross slot 251 of the beam 200 such that the sides 425 and 426 of the link 400 engage the engagement surfaces 261 and 262 of the cross-slot 251 in a friction fit. In addition, the faces 421 and 422 of the link 400 engage the longitudinal engagement surfaces 231 and 232 of the engagement slot 221 and the longitudinal engagement surfaces 235 and 236 of the engagement slot 223 in a friction fit. Furthermore, the aperture 413 of the link 400 aligns with the engagement slot 222 and 224 of the beam 200 and the mid-point of the link 400 aligns with the end 205 of the beam 200.

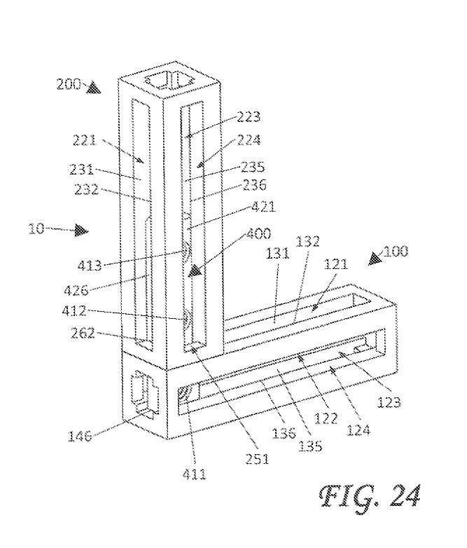

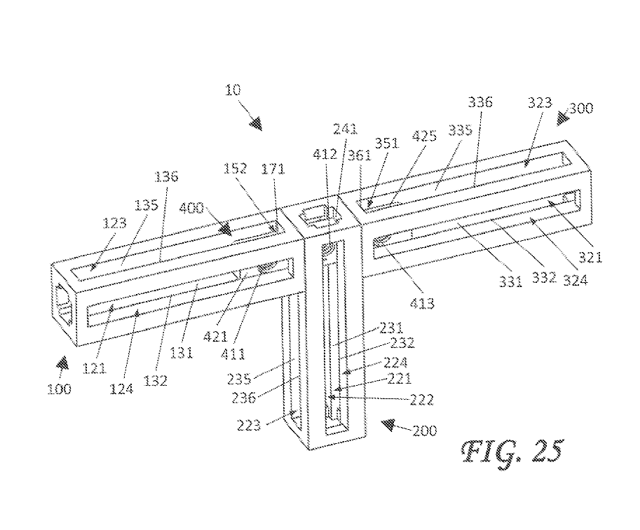

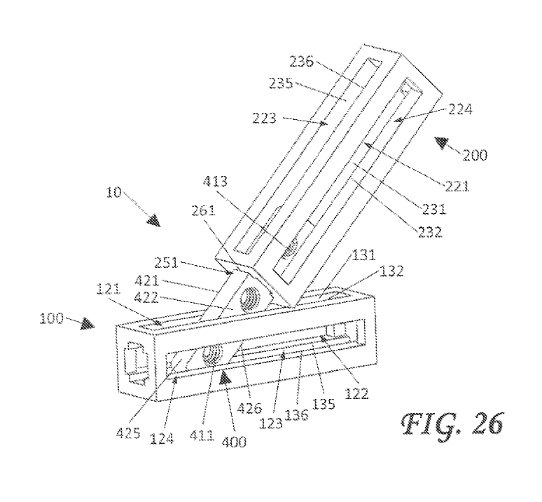

FIG. 24 illustrates a right angle coupling of the beam 100 and the beam 200 using the link 400. The link 400 inserts into the engagement slot 121 and the engagement slot 123 of the beam 100 such that the faces 421 and 422 of the link 400 engage the longitudinal engagement surfaces 131 and 132 of the engagement slot 121 and the longitudinal engagement surfaces 135 and 136 of the engagement slot 123 in a friction fit. In addition, the side 426 of the link 400 engages the end engagement surface 142 of the engagement slot 121 and the end engagement surface 146 of the engagement slot 123. Furthermore, the link 400 inserts through the engagement slot 121 and the engagement slot 123 of the beam 100 such that the aperture 411 of the link 400 aligns with the engagement slot 122 and 124 of the beam 100.

The link 400 then inserts into the cross slot 251 of the beam 200 such that the sides 425 and 426 of the link 400 engage the engagement surfaces 261 and 262 of the cross-slot 251 in a friction fit. In addition, the faces 421 and 422 of the link 400 engage the longitudinal engagement surfaces 231 and 232 of the engagement slot 221 and the longitudinal engagement surfaces 235 and 236 of the engagement slot 223 in a friction fit. Furthermore, the aperture 412 and 413 of the link 400 align with the engagement slot 222 and 224 of the beam 200.

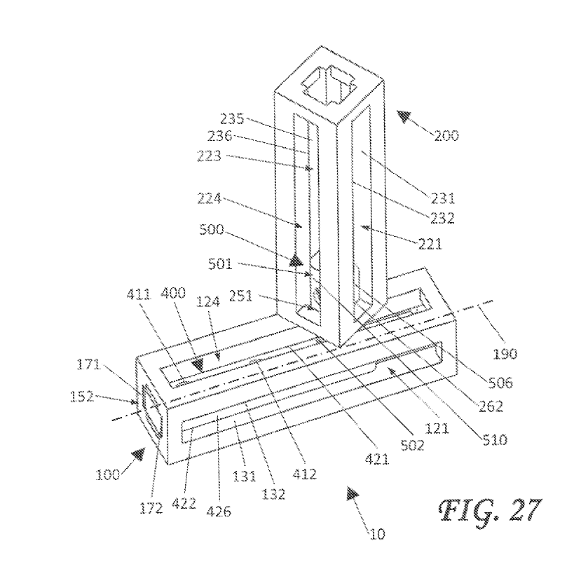

FIG. 25 illustrates a T coupling of the beam 100, the beam 200, and the beam 300 using the link 400. The link 400 inserts into the cross slot 152 of the beam 100 such that the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit. Furthermore, the aperture 411 of the link 400 aligns with the engagement slot 122 and 124 of the beam 100.

The link 400 then inserts into the engagement slot 223 and the engagement slot 221 of the beam 200 such that the faces 421 and 422 of the link 400 engage the longitudinal engagement surfaces 235 and 236 of the engagement slot 223 and the longitudinal engagement surfaces 231 and 232 of the engagement slot 221 in a friction fit. In addition, the side 425 of the link 400 engages the end engagement surface 245 of the engagement slot 223 and the end engagement surface 241 of the engagement slot 221 Furthermore, the link 400 inserts through the engagement slot 223 and the engagement slot 221 of the beam 200 such that the aperture 412 of the link 400 aligns with the engagement slot 222 and 224 of the beam 200.

The link 400 then into the cross slot 351 of the beam 300 such that the sides 425 and 426 of the link 400 engage the engagement surfaces 361 and 362 of the cross-slot 351 in a friction fit. In addition, the faces 421 and 422 of the link 400 engage the longitudinal engagement surfaces 331 and 332 of the engagement slot 321 and the longitudinal engagement surfaces 335 and 336 of the engagement slot 323 in a friction fit. Furthermore, the aperture 413 of the link 400 aligns with the engagement slot 322 and 324 of the beam 300.

FIG. 26 illustrate an angled coupling of the beam 100 with the beam 200 using the link 400. The link 400 inserts approximately at a 45 degree angle into the engagement slot 121 and into the engagement slot 123 of the beam 100 such that the faces 421 and 422 of the link 400 engage the longitudinal engagement surfaces 131 and 132 of the engagement slot 121 and the longitudinal engagement surfaces 135 and 136 of the engagement slot 123 in a friction fit. In addition, the aperture 411 of the link 400 aligns with the engagement slot 122 and 124 of the beam 100.

The link 400 then inserts into the cross slot 251 of the beam 200 such that the sides 425 and 426 of the link 400 engage the engagement surfaces 261 and 262 of the cross-slot 251 in a friction fit. In addition, the faces 421 and 422 of the link 400 engage the longitudinal engagement surfaces 231 and 232 of the engagement slot 221 and the longitudinal engagement surfaces 235 and 236 of the engagement slot 223 in a friction fit. Furthermore, the aperture 413 of the link 400 aligns with the engagement slot 222 and 224 of the beam 200.

FIGS. 27-30 illustrate some example structures that can be constructed using the adapter 500, link 400, the beam 100 and the beam 200. FIGS. 27-30 are not all inclusive of every combination using, the adapter 500, the link 400, the beam 100, and the beam 200.

FIG. 27 illustrates a rotational feature of the modular construction system 10 using the adapter 500, the link 400, the beam 100 and the beam 200. The link 400 inserts into the cross slot 152 of the beam 100 such that the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit.

The stud 502 of the adapter 500 inserts through the engagement slot 124 and engages the aperture 413 of the link 400 to secure the adapter 500 to the link 400 and the beam 100. Furthermore, the engagement of the stud 502 with the of the aperture 413 of the link 400 allows the faces 510 and 511 of the adapter 500 to reside parallel, perpendicular, or any angle between parallel and perpendicular compared to the central axis 190 of the beam 100.

The body 501 of the adapter 500 then inserts through the cross slot 251 of the beam 200 such that the sides 506 and 507 of the body 501 the engagement surfaces 261 and 262 of the cross-slot 251 in a friction fit. Furthermore, the faces 510 and 511 of the adapter 500 engage the longitudinal engagement surfaces 231 and 232 of the engagement slot 221 and the longitudinal engagement surfaces 235 and 236 of the engagement slot 223 in a friction fit.

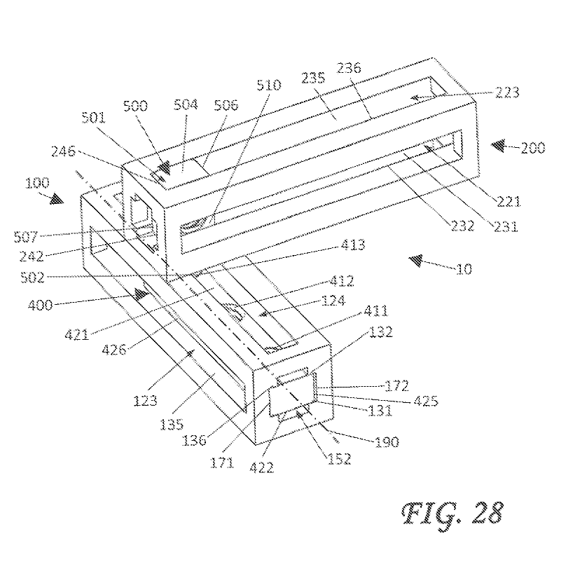

FIG. 28 illustrates a right angle coupling of the modular construction system 10 using the adapter 500, the link 400, the beam 100 and the beam 200. The link 400 inserts into the cross slot 152 of the beam 100 such that the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit. Furthermore, the apertures 411-413 of the link 400 align with the engagement slot 122 and 124 of the beam 100.

The stud 502 of the adapter 500 inserts through the engagement slot 124 and engages the aperture 413 of the link 400 to secure the adapter 500 to the link 400 and the beam 100. Furthermore, the engagement of the stud 502 with the of the aperture 413 of the link 400 allows the faces 510 and 511 of the adapter 500 to reside parallel, perpendicular, or any angle between parallel and perpendicular compared to the central axis 190 of the beam 100.

The adapter 500 inserts into the engagement slot 221 and into the engagement slot 223 of the beam 200. Specifically, the end 504 of the adapter 500 inserts through the engagement slot 221 such that the faces 510 and 511 of the adapter 500 engage the longitudinal engagement surfaces 231 and 232 of the engagement slot 221 and the longitudinal engagement surfaces 235 and 236 of the engagement slot 223 in a friction fit. In addition, the body 501 of the adapter 500 inserts through the engagement slot 221 and the engagement slot 223 such that the side 507 of the adapter 500 engages the end engagement surface 242 of the engagement slot 221 and the end engagement surface 246 of the engagement slot 223 in a friction fit.

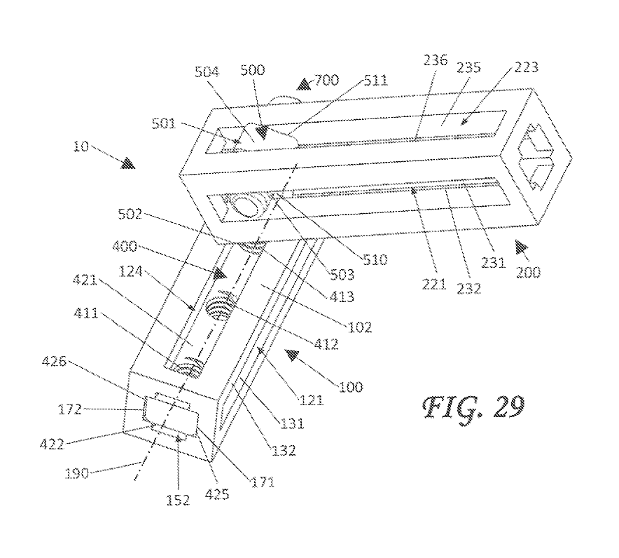

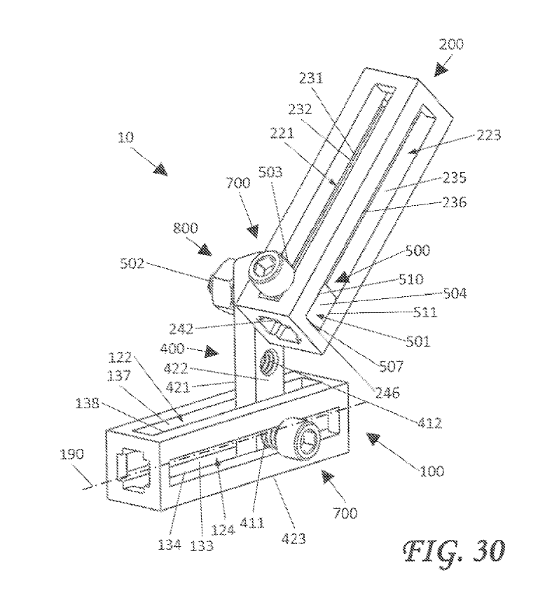

FIG. 29 illustrates an angled coupling of the modular construction system 10 using the adapter 500, the link 400, the beam 100 and the beam 200. The link 400 inserts into the cross slot 152 of the beam 100 such that the sides 425 and 426 of the link 400 engage the engagement surfaces 171 and 172 of the cross-slot 152 in a friction fit. In addition, the faces 421 and 422 of the link 400 engage the longitudinal engagement surfaces 131 and 132 of the engagement slot 121 and the longitudinal engagement surfaces 135 and 136 of the engagement slot 123 in a friction fit. Furthermore, the apertures 411-413 of the link 400 aligns with the engagement slot 122 and 124 of the beam 100.

The stud 502 of the adapter 500 inserts through the engagement slot 124 and engages the aperture 413 of the link 400 to secure the adapter 500 to the link 400 and the beam 100. Furthermore, the engagement of the stud 502 with the of the aperture 413 of the link 400 allows the body 501 of the adapter 500 to reside in a final position that perpendicular compared to the central axis 190 of the beam 100.

The adapter 500 inserts into the engagement slot 221 and into the engagement slot 223 of the beam 200. Specifically, the end 504 of the adapter 500 inserts through the engagement slot 221 such that the faces 510 and 511 of the adapter 500 engage the longitudinal engagement surfaces 231 and 232 of the engagement slot 221 and the longitudinal engagement surfaces 235 and 236 of the engagement slot 223 in a friction fit. The central axis 290 of the beam 200 is moved to reside approximately at a 30-degree angle compared to the side 102 of the beam 100. A bolt 700 inserts through the aperture 503 of the adapter 500 to further secure the angled coupling of the beam 100 with the beam 200.

FIG. 30 illustrates a rotational angled coupling of the modular construction system 10 using the adapter 500, the link 400, the beam 100 and the beam 200. The link 400 inserts into the engagement slot 122 and into the engagement slot 124 of the beam 100. Specifically, the end 423 of the link 400 inserts into the engagement slot 122 and into the engagement slot 124 such that the faces 421 and 422 of the link 400 engage the longitudinal engagement surfaces 133 and 134 of the engagement slot 122 and the longitudinal engagement surfaces 137 and 138 of the engagement slot 124 in a friction fit. The stud 502 of the adapter 500 engages the aperture 413 of the link 400 to secure the adapter 500 to the link 400 and the beam 100. The adapter 500 inserts through the engagement slot 221 and into the engagement slot 223 of the beam 200. Specifically, the end 504 of the adapter 500 inserts through the engagement slot 221 such that the faces 510 and 511 of the adapter 500 engage the longitudinal engagement surfaces 231 and 232 of the engagement slot 221 and the longitudinal engagement surfaces 235 and 236 of the engagement slot 223 in a friction fit. In addition, the body 501 of the adapter 500 inserts through the engagement slot 221 such that the side 507 of the adapter 500 engages the end engagement surface 242 of the engagement slot 221 and the end engagement surface 246 of the engagement slot 223. The bolts 700 insert through the aperture 503 of the adapter 500 and the aperture 411 of the link 400 to further secure the coupling of the beam 100 with the beam 200. Furthermore, the beam 200 is then placed at an angle that is approximately 45 degrees compared to the central axis 190 of the beam 100 and the nut 800 engages adapter 500 to secure the beam 200 at the desired angle.

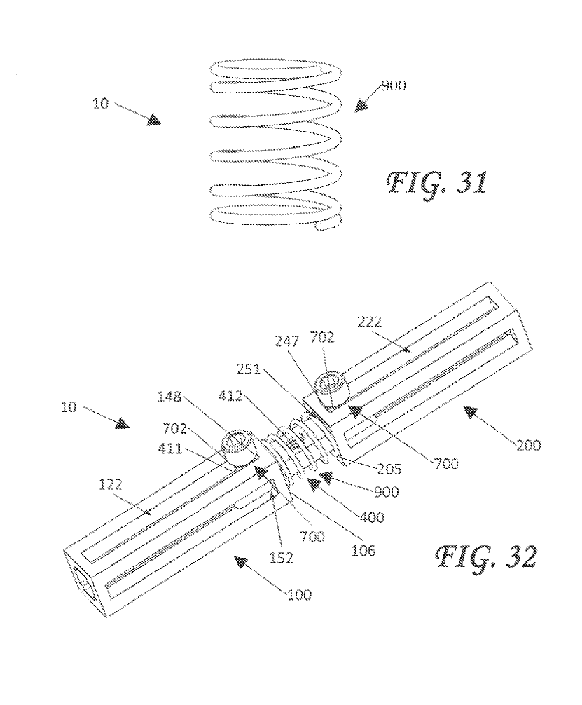

FIG. 31 illustrates the biasing member 900. The biasing member 900 is used in the modular construction system 10 to impart movement into the modular construction system 10. In the preferred embodiment, the biasing member 900 is a spring. FIG. 32 illustrates the biasing member 900 placed over the link 400 and between the beam 100 and the beam 200 to allow the beam 100 and the beam 200 to be compressed toward each other and biased away from each other. In particular, the link 400 inserts into the cross slot 152 as described above such that the aperture 411 of the link 400 aligns with the engagement slot 122 and 124 of the beam 100. The stud 702 of the bolt 700 inserts through the engagement slot 122 and into the aperture 411 to maintain the link 400 within the beam 100. The biasing member 900 inserts over the link 400 so that a first end of the biasing member 900 resides adjacent to the end 106 of the beam 100. The link 400 then inserts into the cross slot 251 of the beam 200 such that the aperture 413 of the link 400 aligns with the engagement slot 222 and 224 of the beam 200. Furthermore, a second end of the biasing member 900 resides adjacent to the end 205 of the beam 200. The stud 702 of the bolt 700 inserts through the engagement slot 222 and into the aperture 413 to maintain the link 400 within the beam 200. A compression force may be imparted into the beam 100 and the beam 200 such that the end 106 of the beam 100 moves toward the end 205 of the beam 200. The compression force is stored within the biasing member 900. Upon release of the compression force, the biasing member 900 biases the beam 100 and the beam 200 away from each other. Specifically, the biasing member 900 bias the beam 100 until end engagement surface 148 contacts the stud 702 of the bolt 700 and the biasing member 900 bias the beam 200 until the end engagement surface 247 contacts the stud 702 of the bolt 700.

1. A modular construction system adapted to create structures, comprising:
a link having a central axis and including a first end and a second end;
a first beam including sides and ends, wherein the sides of the first beam each include an engagement slot adapted to receive the link and maintain engagement therewith through a friction fit, further wherein the ends of the first beam each include a cross-slot adapted to receive the link and maintain engagement therewith through a friction fit; and
a second beam including sides and ends, wherein the sides of the second beam each include an engagement slot adapted to receive the link and maintain engagement therewith through a friction fit, further wherein the ends of the second beam each include a cross-slot adapted to receive the link and maintain engagement therewith through a friction fit such that the link connects the first beam with the second beam.

2. The modular construction system adapted to create structures according to claim 1, wherein the link facilitates arrangement of the first and second beam in a side-to-side configuration, a side-to-end configuration, or an end-to-end configuration.

3. The modular construction system adapted to create structures according to claim 1, wherein the link facilitates arrangement of the first and second beam in an angled configuration whereby the first end of the link resides within an engagement slot of either the first or second beam such that the central axis of the link resides at any angle between a perpendicular and a 45 degree angle relative to a central axis of either the first or second beam.

4. The modular construction system adapted to create structures according to claim 3, wherein the second end of the link resides within an engagement slot of the first or second beam.

5. The modular construction system adapted to create structures according to claim 3, wherein the second end of the link resides within a cross slot of the first or second beam.

6. The modular construction system adapted to create structures according to claim 3, wherein the link facilitates arrangement of the first and second beam in a side by side configuration whereby the first end of the link resides within an engagement slot of either the first or second beam, such that the central axis of the link is at a 45 degree angle relative to the central axis of the first or second beam and the second end of the link resides within an engagement slot of the first or second beam.

7. The modular construction system adapted to create structures according to claim 1, wherein the link facilitates arrangement of the first and second beam in an end to end configuration whereby the first end of the link resides within a cross slot of either the first or second beam and the second end of the link resides within a cross slot of the first or second beam.

8. The modular construction system adapted to create structures according to claim 1, further comprising a third beam including sides and ends, wherein the sides of the third beam each include an engagement slot adapted to receive the link and maintain engagement therewith through a friction fit, further wherein the ends of the third beam each include a cross-slot adapted to receive the link and maintain engagement therewith through a friction fit such that the link connects together the first, second, and third beam.

9. The modular construction system adapted to create structures according to claim 8, wherein the link facilitates the arrangement of the first, the second, and a third beam in a side-to-side configuration.

10. The modular construction system adapted to create structures according to claim 3, wherein the link facilitates the arrangement of the first and second beams and a third beam whereby the link traverses engagement slots of the first beam and engages a cross-slot of the second and third beams.

11. The modular construction system adapted to create structures according to claim 1, comprising:
a plurality of links each having a central axis and including a first end and a second end;
a plurality of beams each including sides and ends, wherein each side of the plurality of beams includes a slot adapted to receive a link and maintain engagement therewith through a friction fit, further wherein each end of the plurality of beams include a cross-slot adapted to receive a link and maintain engagement therewith through a friction fit; and
the engagement of the plurality of links with the engagement slots and cross-slots of the plurality of beams facilitates arrangement of the plurality of beams into structures.

12. The modular construction system adapted to create structures according to claim 1, wherein the link includes a plurality of apertures.

13. The modular construction system adapted to create structures according to claim 12, further comprising a first adapter including a stud and a body adapted to engage the cross-slots and engagement slots of the first and second beam, wherein the body includes faces and an aperture adapted to receive a bolt or a stud of a second adapter and the stud is adapted to engage the apertures of the link or an aperture of the second adapter.

14. The modular construction system adapted to create structures according to claim 13, comprising:
a plurality of adapters each including a stud and a body adapted to engage cross-slots and engagement slots of a plurality of beams, wherein each body includes faces and an aperture adapted to receive a bolt or a stud of another adapter and the stud is adapted to engage the apertures of the link or an aperture of another adapter.

15. The modular construction system adapted to create structures according to claim 14, wherein insertion of the first end of the link through an engagement slot of the first beam such that the central axis of the link resides at a perpendicular angle relative to a central axis of the first beam aligns an aperture of the link with adjacent engagement slots of the first beam, further wherein, a bolt or a stud of the first adapter received in the aperture locks the link with the first beam.

16. The modular construction system adapted to create structures according to claim 15, wherein insertion of the second end of the link through an engagement slot of the second beam such that the central axis of the link resides at a perpendicular angle relative to a central axis of the second beam aligns an aperture of the link with adjacent engagement slots of the second beam, further wherein, a bolt or a stud of the second adapter in the aperture locks the link with the second beam, thereby coupling the first and second beams.

17. The modular construction system adapted to create structures according to claim 16, wherein insertion of the second end of the link through an engagement slot of a third beam such that the central axis of the link resides at a perpendicular angle relative to a central axis of the third beam aligns an aperture of the link with engagement slots of the third beam, further wherein, a bolt or a stud of a third adapter received in the aperture locks the link with the third beam, thereby coupling the first, second, and third beams.

18. The modular construction system adapted to create structures according to claim 15, wherein the link traverses the engagement slots of the first beam such that apertures of the link reside outside the first beam and are able to engage the second beam and a third beam.

19. The modular construction system adapted to create structures according to claim 18, wherein insertion of the second end of the link through a cross slot of the second beam aligns an aperture of the link with engagement slots of the second beam such that a bolt or a stud of the second adapter received in the aperture locks the link with the second beam, thereby coupling the first and second beams.

20. The modular construction system adapted to create structures according to claim 19, wherein insertion of the first end of the link through a cross slot of a third beam aligns an aperture of the link with engagement slots of the third beam such that a bolt or a stud of a third adapter received in the aperture locks the link with the third beam, thereby coupling the first, second, and third beams.

21. The modular construction system adapted to create structures according to claim 13, wherein insertion of the first end of the link through a cross slot of the first beam aligns an aperture of the link with engagement slots of the first beam such that a bolt or a stud of the first adapter received in the aperture locks the link with the first beam.

22. The modular construction system adapted to create structures according to claim 21, wherein insertion of the second end of the link through a cross slot of the second beam aligns an aperture of the link with engagement slots of the second beam such that a bolt or a stud of the second adapter received in the aperture locks the link with the second beam, thereby coupling the first and second beams.

23. The modular construction system adapted to create structures according to claim 14, wherein the stud of the first adapter is positionable within the aperture of the link such that the faces of the first adapter reside parallel, perpendicular, or any angle between parallel and perpendicular to the central axis of the link.

24. The modular construction system adapted to create structures according to claim 23, wherein the stud of the first adapter inserts through an aperture of the link such that a nut or an aperture of the second adapter engaging the stud locks the first adapter to the link.

25. The modular construction system adapted to create structures according to claim 24, wherein insertion of the body of the first adapter through an engagement slot of the first or second beam aligns the aperture of the first adapter with adjacent engagement slots of the first or second beam such that a bolt or the stud of the second adapter received in the aperture locks the first adapter with the first or second beam, thereby coupling the link and the first or second beam.

26. The modular construction system adapted to create structures according to claim 25, wherein the central axis of the first or second beam resides at an angle between 0 and 30 degrees compared to the body of the link.

27. The modular construction system adapted to create structures according to claim 24, wherein insertion of the body of the first adapter through a cross slot of the first or second beam aligns the aperture of the first adapter with engagement slots of the first or second beam such that a bolt or the stud of the second adapter received in the aperture locks the first adapter with the first or second beam, thereby coupling the link and the first or second beam.

28. The modular construction system adapted to create structures according to claim 23, wherein insertion of the first end of the link through a cross slot of the first or second beam aligns an aperture of the link with adjacent engagement slots of the first or second beam such that the stud of the first adapter received in the aperture locks the first adapter with the first or second beam, further wherein, the stud of the first adapter is positionable within the aperture of the link such that the faces of the adapter reside parallel, perpendicular, or any angle between parallel and perpendicular to a central axis of the first beam or second beam.

29. The modular construction system adapted to create structures according to claim 28, wherein insertion of the body of the first adapter through an engagement slot of the first or second beam aligns the aperture of the first adapter with adjacent engagement slots of the first or second beam, such that a bolt or the stud of the second adapter received in the aperture locks the first adapter with the first or second beam, thereby coupling the first and second beams.

30. The modular construction system adapted to create structures according to claim 29, wherein the central axis of the first or second beam resides at an angle between 0 and 30 degrees compared to the body of the link.

31. The modular construction system adapted to create structures according to claim 28, wherein insertion of the body of the first adapter through a cross slot of the second beam aligns the aperture of the first adapter with adjacent engagement slots of the second beam, such that a bolt or the stud of the second adapter received in the aperture locks the first adapter with the second beam, thereby coupling the first and second beams.

32. The modular construction system adapted to create structures according to claim 14, further comprising a plate including apertures adapted to receive the stud of the first adapter, wherein, the first adapter facilitates the coupling of the plate and the first or second beam.

33. The modular construction system adapted to create structures according to claim 32, wherein the stud of the first adapter inserts through an aperture of the plate such that a nut engaging the stud locks the first adapter to the plate.

34. The modular construction system adapted to create structures according to claim 33, wherein insertion of the body of the first adapter through an engagement slot of the first or second beam aligns the aperture of the first adapter with adjacent engagement slots of the first or second beam such that a bolt or the stud of the second adapter received in the aperture locks the first adapter with the second beam, thereby coupling the plate and the first or second beam.

35. The modular construction system adapted to create structures according to claim 34, wherein insertion of the body of the first adapter through a cross slot of the first or second beam aligns the aperture of the first adapter with engagement slots of the first or second beam such that a bolt or the stud of the second adapter received in the aperture locks the first adapter with the first or second beam, thereby coupling the plate and the first or second beam.

36. The modular construction system adapted to create structures according to claim 32, further comprising a biasing member.

37. The modular construction system adapted to create structures according to claim 36, wherein insertion of the first end of the link through a cross slot of the first beam aligns an aperture of the link with engagement slots of the first beam such that a bolt or a stud of the first adapter received in the aperture locks the link with the first beam.

38. The modular construction system adapted to create structures according to claim 37, wherein the biasing member inserts over the link such that a first end of the biasing member engages an end of the first beam.

39. The modular construction system adapted to create structures according to claim 38, wherein insertion of the second end of the link through a cross slot of the second beam aligns an aperture of the link with engagement slots of the second beam such that a bolt or a stud of the second adapter received in the aperture locks the link with the second beam, thereby coupling the first and second beams, further wherein, a second end of the biasing member engages an end of the second beam.

40. The modular construction system adapted to create structures according to claim 39, wherein a compression force imparted into the first and second beam moves the first beam and second beam toward each other, further wherein, upon release of the compression force the biasing member bias the first and second beam away from each other.

41. A method of creating structures, comprising:
providing a plurality of links each having a central axis and including a first end and a second end;
providing a plurality of beams each including sides and ends, wherein each side of the plurality of beams includes a slot adapted to receive a link and maintain engagement therewith through a friction fit, further wherein each end of the plurality of beams includes a cross-slot adapted to receive a link and maintain engagement therewith through a friction fit;
providing a plurality of adapters each including a stud and a body adapted to engage cross-slots and engagement slots of a plurality of beams, wherein each body includes faces and an aperture adapted to receive a bolt or a stud of another adapter, further wherein the stud is adapted to engage the apertures of a link or an aperture of another adapter;
providing a plurality of plates each including apertures adapted to receive a stud of an adapter, wherein, the adapter facilitates the coupling of a plate and a beam;
providing a plurality of biasing members;
combining the plurality of links, the plurality of beams, the plurality of adapters, the plurality of plates, and the plurality of biasing members using bolts, nuts, and the studs of the adapters to create structures.
